(19) United States
(12) Patent Application Publication
(10) Pub. No.: US 2015/0317581 A1
(43) Pub. Date: Nov. 5, 2015

(54) SYSTEM AND METHOD FOR PROVIDING REAL ESTATE REFERRALS

(71) Applicant: Mazen N. Fawaz, Pacific Palisades, CA (US)

(72) Inventor: Mazen N. Fawaz, Pacific Palisades, CA (US)

(21) Appl. No.: 14/703,230

(22) Filed: May 4, 2015

Related U.S. Application Data
(63) Continuation-in-part of application No. 13/677,381, filed on Nov. 15, 2012.
Application No. 13/677,381 is a continuation of application No. 13/417,461, filed on Mar. 12, 2012, now Pat. No. 8,332,330.
Application No. 13/417,461 is a continuation of application No. 12/243,047, filed on Oct. 1, 2008, now Pat. No. 8,140,443.

(51) Int. Cl. G06Q 10/06

(52) U.S. Cl. CPC G06Q 10/0639; G06Q 10/063112; G06Q 50/16

(57) ABSTRACT

The present invention discloses a system and method for providing agent referrals for real estate transactions. The system and method provides buyers and/or sellers with a real estate agent referral based on the type of real estate involved in the transaction and/or preferences of the buyer/seller. The real estate agent provided through the referral will be the highest performing real estate available with the performance of the real estate agent based on criteria received from the seller/buyer and transaction history of the real estate agent.

### CROSS REFERENCE TO RELATED APPLICATIONS

The present application is a continuation-in-part of, and is entitled to the benefit of the earlier filing date and priority of, co-pending U.S. patent application Ser. No. 13/677,381 entitled “SYSTEM AND METHOD FOR PROVIDING REAL ESTATE REFERRALS,” filed Nov. 15, 2012, the disclosure of which is hereby incorporated by reference.

### FIELD OF THE INVENTION

The present invention generally relates to systems and methods for ranking real estate agents. More particularly, the present invention relates to a system and method for ranking real estate agents and providing the real estate agent referrals for real estate transactions.

### BACKGROUND

The purchase or sale of real estate is a very complex transaction whether involving a commercial or residential property. Such transactions typically involve a large sum of money and many different variables that must be taken into consideration prior to closing. For most people a real estate transaction can be one of the most important transactions in their life. Based on the complexity and nature of real estate transactions buyers and sellers typically utilize real estate agents to manage many of the details of the transaction and ultimately close the sale of the real estate. As such, it is important that the buyer or seller utilize an agent which is experienced with the type of real estate involved in the transaction as well as the many details involved. It is also very important that the real estate agent be able to effectively communicate and develop a good relationship with their client such that the client may be effectively served.

With the need for buyers and sellers to have an experienced real estate agent representing them in the real estate transactions, buyers and sellers often use referrals to select a particular real estate agent. By utilizing a referral, a buyer or seller can be somewhat assured that they are utilizing a reputable agent based on the relationship of the buyer/seller with the referring entity. This helps alleviate the uncertainty factor in the mind of the buyer/seller when selecting a real estate agent at random. Such referrals may be provided through a personal contact or a reputable company which provides real estate agent referrals.

Many companies that provide real estate referrals utilize methods and systems which help match a buyer/seller with a real estate agent. An example of one type of referral system is described in U.S. Pat. No. 6,883,002 to Faudman. Faudman describes a system and process which maintains a database of MLS properties for sale. Real estate agents subscribe to the system and are included into the database with their information. Prospective buyers or sellers then enter the system by submitting a commitment form with personal information and the type of property involved. Upon entering the system, the subscribing real estate agents may then view the information of prospective buyers and sellers and post properties for sale.

Another type of system is disclosed in U.S. Pat. Pub. No. 2004/0088172 to Baglioni. Baglioni describes a method and apparatus for real estate agent selection. The method and apparatus described by Baglioni ranks real estate agents based on performance and provides a referral of the highest ranking real estate agent to potential clients. The performance of the real estate agents is determined based on earnings over a designated time period. If the customer is dissatisfied with the referred real estate agent, feedback from the customer may be used to reevaluate the ranking of the referred agent.

While there are various systems and methods currently known for providing referrals, particularly real estate referrals, such systems and methods fail to take into consideration the performance of the real estate agents with respect to the many details of specific properties and the transactions associated therewith. As such, there is a need in the art for a system and method which provides an agent referral for real estate transactions that takes into account the specific details for each real estate transaction and the performance of the real estate agents.

### SUMMARY OF THE INVENTION

Disclosed herein, is a method for providing a referral of a ranked real estate agent through a real estate agent referral system. The method may comprising the steps of receiving search criteria from a user with respect to the purchase or sale of a real estate property; receiving performance data for two or more real estate agents, and ranking by a computer two or more real estate agents based on the search criteria received from the user and the performance data of the two or more real estate agents to create a set of agent search results including the highest ranking real estate agent or a listing of the highest ranking real estate agents based on the search criteria. The search results may include performance data for the highest ranking real estate agent or each of the real estate agents listed in the listing of the highest ranking real estate agents. Upon creation of the set of agent search results, the set of agent search results may be displayed to the user through a web based user portal displayed on a personal computer or a mobile device whereby the web based user portal allows the user to view the agent search results and select a real estate agent from the agent search results. The agent referral system may also allow the user to provide one or more additional sets of search criteria, wherein the agent search results for each additional set of search criteria are displayed in the web based user portal.

The set of agent search results may be in the form of a list of one or more properties, wherein each specific property included in the list of one or more properties displays the top ranked real estate agent or the listing of the highest ranking real estate agents for the specific property. The list of one or more properties may be continually updated based on changes in the listing data of the one or more properties included in the list of one or more properties.

The set of agent search results provided to the user may be anonymous with respect to the one or more real estate agents. When the set of agent search results is anonymous, the contact information for the agent selected by the user may be populated into the web based user portal upon the selected agent agreeing to represent the user and accepting the terms of the real estate agent referral system.

The web based user portal may also store the set of agent search results within the web based user portal for retrieval by the user. The stored set of agent search results may be updated based on changes in the performance data for the one or more real estate agents included in the set of agent search results. The web based user portal may also allow the user to terminate the relationship with the real estate agent selected by the user. This may be performed by selecting an option available within the web based user portal. The web based user portal may also include an option for the user to select another agent from the set of agent search results upon terminating the relationship with the initially selected agent.

The method for providing a referral of a ranked real estate agent may also include the step of communication interface between the user and the selected agent. This may be created between the web based user portal and a web based agent portal. The web based agent portal may allow the selected agent to view personal information of the user and communicate with the user. The personal information of the user may be populated into the web based user portal once the selected agent agrees to represent the user and agrees to the terms of the real estate agent referral system. The web based agent portal may also include a schedule function which allows the agent to post available times viewable to the user and schedule appointments with the user.

### BRIEF DESCRIPTION OF THE DRAWINGS

FIG. 1, is a depiction of an agent scorecard in accordance with the present invention.

FIG. 2, is flowchart generally depicting the steps in the financial calculator functionality in accordance with the present invention.

FIG. 3, is a depiction of the output of the financial calculator in accordance with the present invention.

### DETAILED DESCRIPTION OF THE PREFERRED EMBODIMENTS OF THE INVENTION

In accordance with the present invention there is provided a system and method for ranking two or more real estate agents with respect to one or more real estate properties. The two or more real estate agents may be ranked based on their past performance in representing buyers or sellers with regard to the purchase or sale of a specific type of property. The specific type of property may be specified by a potential buyer or seller. Alternatively, the specific property may be listed as one or more search results from a property browsing website or web application accessed or running on a personal computer or mobile device. Once the two or more real estate agents are ranked with respect to a specified real estate property, the highest performing real estate agent may be referred or displayed to potential buyers and sellers based on availability.

The method disclosed herein may provide buyers and sellers with a referral to the highest ranking real estate agent based on past performance of the ranked real estate agent with respect to a specific property or property type. The utilization of performance data for the two or more real estate agents may provide an unbiased ranking based on performance of the two or more real estate agents while taking into account characteristics surrounding a particular type of real estate transaction. With such considerations being made during the ranking process, a high performing real estate agent may be referred to a potential buyer or seller thereby enabling an effective real estate transaction.

In addition to the past performance of the two or more real estate agents, the personal preferences of the buyer or seller may be utilized to calculate the ranking of the two or more real estate agents. By utilizing the personal preferences of the buyer to provide the ranking of the two or more real estate agents, the resulting ranking of the two or more real estate agents may be better matched to the potential buyer or seller.

The method for ranking two or more real estate agents may generally comprise the steps of receiving information relating to a real estate property, receiving performance data for two or more real estate agents, and ranking the two or more real estate agents based on the information relating to the real estate property and performance data of the two or more real estate agents. Once the ranking of two or more real estate agents is created, a referral of the highest performing real estate agent may be provided to a potential buyer or seller.

The property information for the real estate property may comprise one or more types of data selected from the geographic area of the real estate property, address of the real estate property, the price range of the real estate property, the current listing price of the real estate property, the desired listing price of the real estate property, the type of real estate property, the time the real estate property has been on the market, and the name of the current owner of the real estate property. The real estate property information may be acquired via one or more sources such as the public domain, databases, MLS systems and a potential buyer or seller of the real estate property. Specific examples of sources of real estate property information may include public record data (crime data, education data, demographic data), county data (deeds, title history, tax records), state data (Real Estate Commission licensee history, Real Estate Commission disciplinary records, State corporate records, property and parcel maps, court records), MLS data (historical MLS data feeds, agent/office classes with member databases), Trade Association Data (National Association of Realtors data feed with membership records, State Association of Realtors data feed with membership records), Individual Brokerage Feeds (historical data feeds signed with individual brokerages or agents), social network data (Twitter® API, Facebook® API, Yelp® API, Vine®/Snapchat®, etc.), Federal Data (HUD1), Settlement Statement (Tax records), Mapping and Geographic Systems Data (Google® Maps API, Bing® Maps API, Maponics® mapping data+polygons, Onboard Informatics mapping data+polygons), and consumer financial data (credit reports, mortgage records). The MLS system is a primary example of a real estate database that may provide performance information to rank the two or more real estate agents. The MLS system includes information such as area, price range, volume, type of property, listing/selling price, and listing/selling date. The MLS system comprises many separate databases located in different geographical regions. The MLS system may provide data in a typical database format, a spreadsheet format, or a website format. Data may be received from the databases by 1) being granted full access to download data, 2) being granted access upon periodic entry of a randomly generated security code, 3) being sent files which include the database information, and 4) website access whereby a designated number of files may be viewed or downloaded at a specific time.

If the property related information is provided from a potential buyer or seller, additional information regarding the buyer or seller may also be provided which may also be utilized to rank the two or more real estate agents. The information received from the buyer or seller may comprise one or more inputs which may be mandatory or optional depending on the desired outcome. The information from the buyer or seller may be selected from the geographic area of the property to be purchased or sold, the price range of the property to be purchased or sold, personal preferences of the buyer or seller, the type of property, time property has been on the market, the name of current property owner, full name of buyer or seller, address of buyer or seller, age of buyer or seller, phone number of buyer or seller, email address of buyer or seller, and desired closing date. The personal preferences of the buyer or seller may include one or more selected from the fluency of the real estate agent in a particular language, family status of the real estate agent, gender of the real estate agent, age of the real estate agent, whether or not the real estate agent is a pet owner, and time period for retrieving agent performance data for analysis (e.g. last 3 years). The reason for acquiring such qualitative data from the buyer or seller is to create a comfort level between the buyer or seller and real estate agent and to provide a real estate agent who understands the preferences and needs of the buyer or seller. For example, a buyer may have a large family and desire the real estate agent representing them to understand the intricacies involved when purchasing a house for a family of a certain size. As such, the buyer would desire the agent to have personal experience that would allow the agent to fully understand the current condition of the buyer such that all the needs of the buyer will be taken into account during the real estate transaction.

As discussed, the property information may be received from the public domain, databases, MLS systems, or from the buyer or seller. Information from the buyer or seller may be provided either electronically or by hard copy. In the case of a hard copy, the buyer or seller may complete a form with all of the required information and submit to the referral service provider. In the case of electronically submitted information, the buyer or seller may fill out and submit an online form or email an electronic form. The information may also be received from the buyer or seller via an interview which may take place in person, by telephone, or any other communication medium.

Once information is received from a buyer or seller, a follow-up communication may be performed to verify the buyer or seller. The follow-up communication is performed to verify the data supplied by the buyer or seller, verify the buyer or seller is an actual person, and/or provide customer service to the buyer or seller. The follow-up communication may also be used to acquire some additional data from the buyer or seller with regard to the type of real estate agent the buyer or seller is seeking The follow-up communication may be performed by email, text message, online chat, video call, VOIP, website/platform, telephone, or other types of electronic communication.

The performance data utilized to rank the one or more real estate agents may be quantitative data and/or qualitative data. The performance data for the two or more real estate agents may comprise one or more types of data selected from volume of sales, volume of sales within given price ranges, listing time for properties, listing price versus selling price for the properties handled by the one or more real estate agents, number of years of experience, type of properties handled by the one or more real estate agents, feedback from clients, feedback from other real estate agents, escrow times, ability to double-end a deal, ability to attract cash buyers, and responsiveness.

The performance data used to rank the two or more real estate agents may be acquired from real estate databases, surveys, interviews, websites, public records and any other source of real estate agent information as previously described. Once acquired, all of the real estate agent information, including the real estate agent rankings, may be maintained in a central database with continual updating as needed. Real estate agents may continue to be added to or removed from the centralized database as needed. Real estate agent rankings may also be continually modified based on the availability of new data in relation to new sales of real estate properties. Additionally, the real estate rankings may be modified based on feedback from represented buyers or sellers. By utilizing a centralized database, the accessibility of the data for future use may be significantly improved, as it is often difficult to acquire real estate data from multiple sources as needed on a timely basis.

The ranking of the two or more real estate agents may be obtained by calculating with a computer a performance matching value for each of the two or more real estate agents indicative of how well the performance data of each of the two or more real estate agents match the property information of one or more specified real estate properties. Additionally, the calculation may include information from a potential buyer or seller which may further include preferences of the potential buyer or seller. The ranking of the real estate agents based on performance data of the real estate agents may be performed based on a calculation performed on the performance data and/or filtering of the performance data. To perform the calculation, the computer may utilize a data analysis algorithm capable of utilizing the performance data for the two or more real estate agents and property information related to a specific type of property to calculate a single value indicative of the performance of each of the two or more real estate agents with respect to the specific type of property (performance matching value or PMV).

Additional details regarding calculations, algorithms and processes that may be used to obtain a performance matching value in accordance with the present invention are disclosed in U.S. Pat. Nos. 8,140,443 and 8,332,330, the disclosures of which are hereby incorporated by reference.

The data used to calculate the performance matching value may be quantitative data and/or qualitative data. In the case of qualitative data, numerical values may be assigned to certain pieces of qualitative data based on the type of information. Weighting may also be used to assign a numerical value to the qualitative data or modify the numerical value assigned to the qualitative data. The quantitative data may also be weighted based on the importance of the type of information. Various weighting values may be assigned to the fields based on the importance of a particular field in relation to the transaction for which the referral is received. The weighting values may be predetermined in the data analysis algorithm. Along with the initial information received from the buyer or seller, the buyer or seller may also provide weighting values based on the importance of certain factors involved in the real estate transaction, such values being used by the algorithm when performing the calculation. Assigning various weights based on input of the buyer or seller may also be performed by an algorithm utilized within the system.

To calculate the performance matching value, the computer utilizes a data analysis algorithm as previously described. In one example, the data analysis algorithm may include the following steps:

1. Gather user inputs including core/required user inputs (e.g. geography of the property, buy/sell) and optional inputs (e.g. address, price, location, property type, language preference, pet owner, age of home).

2. Identify all agents active in geography (Geography could be determined by system administrator or by the user).

3. Analyze performance of agents for their transactions within user specified criteria (“information from buyer/seller”).

4. Analyze performance of agents active in the area for all transactions, whether or not they are within user specific criteria (“total transactions”).

5. Rank agents based on a score provided from the agent analysis.

In another example, the data analysis algorithm may analyze performance of agents per transaction for a “comparable sales” approach. This example may include the following steps:

1. Gather user inputs including core/required user inputs (e.g. geography of the property, buy/sell) and optional inputs (e.g. address, price, location, property type, language preference, pet owner, age of home).

2. Identify all agents active in geography (Geography could be determined by system administrator or by the user).

3. Analyze performance of agents for their transactions within user specified criteria (“information from buyer/seller”).

4. Analyze performance of agents active per transaction to highlight specific transactions with showing exceptional performance or a high score for a specific property transaction (“comps approach”).

5. Rank agents based on a score provided from the agent analysis.

In yet another example, the agents may be analyzed without use of information input by the user. Such an example may include the following steps:

1. Identify all agents active in specific geography (Geography could be determined by system administrator).

2. Analyze performance of agents for their transactions within the specific geography (“information from buyer/seller”).

3. Analyze performance of agents active in the specified geography for all transactions.

4. Rank agents based on a score provided from the agent analysis.

After ranking the two or more real estate agents, an agent interview filter may be used to confirm additional information prior to providing the referral of the real estate agent to the buyer or seller. Examples of information that may be confirmed by the agent interview filter include availability of the agent, willingness of agent to enter into agreement with referral service provider, willingness of agent to perform service, and responsiveness of agent. Agents who do not meet one or more criteria in the agent interview filter may be removed from consideration or receive a modified performance matching value resulting in a lower ranking for the real estate agent. The agent interview filter may be performed by telephone interview, face to face interview, email communications, text message, or any other type of communication.

The system for ranking two or more real estate agents (“real estate agent ranking system”) may be accessed via an internet based website or an application with access to the internet for use on a mobile device such as a smart phone or tablet. In the case of mobile devices, a specially designed application (“client application” or “client app”) may provide the interface with the online service. The website or client application may enable the users to input their specific needs, conduct different types of analysis of agent performance, view the results of their analyses, and select their preferred agent or agents.

To begin use of the real estate agent ranking system, users may input search criteria into the system via a website accessed by a personal computer or a mobile device as described herein. Search criteria input from the user may include one or more selected from the geographic area of a real estate property, the price range of a real estate property, the type of real estate property (e.g. commercial or residential), the amount of time a real estate property has been on the market, the name of current real estate property owner, the desired closing date, and the personal preferences of the user. The personal preferences of the user may include one or more selected from the fluency of the real estate agent in a particular language, family status of the real estate agent, gender of the real estate agent, age of the real estate agent, and whether or not the real estate agent is a pet owner. The search criteria may be used by the system to provide one or more sets of agent search results including ranked real estate agents as described herein.

When inputting search criteria into the system, the user may submit personal information and register with the system or may decline to enter personal information and remain anonymous. If the user decides not to provide personal information and remains anonymous, the user may be allowed to browse the agent search results in a limited fashion. In the case of an anonymous user, contact information for the ranked real estate agents may not be provided until the user provides personal contact information and registers with the system.

The user may register with the system prior to or after the user initially submits search criteria and receives the agent search results. To register with the system, the user may submit personal information to the system. The user's personal information may include one or more selected from name, address, age, phone number, email address, and credit card information. Submission of the personal information may be necessary for the user to be provided with the contact information of the ranked real estate agents. Submission of credit card information may allow the user to purchase goods or services through the system. Upon entering the personal information, the user may be prompted to create a username and password to finalize registration with the system. The username and password may allow the user to access a web based user portal which may be generated for each user which provides various functionalities to registered users. The web based user portal generated for each user may be accessed via a website or a mobile device application. Upon registration an email may be sent to the user confirming registration. The confirming email may also provide a link to the generated web based user portal.

Upon inputting the search criteria into the system, the system may prepare a set of agent search results which may include the ranking of real estate agents based on the search criteria submitted by the user. The agent search results may include contact information for the one or more ranked real estate agents or the information may be anonymous with respect to the real estate agents. The agent search results may be displayed to the user via the user's personal computer or mobile device. In one example, the information may be provided to the user once the system is finished creating the search results based on the search criteria submitted by the user via the website or mobile application. In such case, the user will remain active on the website or mobile application until the agent search results are created by the system and displayed to the user. Alternatively, an email with the agent search results or a link to a generated web based user portal containing the agent search results may be sent to the user. To perform this function, the user will need to submit an email address during the registration process. In one example, the email will be sent to the user within 24 hours of submission of search criteria.

The agent search results may include the rankings and performance data of one or more real estate agents based on the search criteria submitted by the user. In the case of search results for one agent being displayed, the displayed agent may be the top performing agent as determined by the data analysis algorithm. The performance data may include the performance rankings of the one or more real estate agents with respect to various performance categories such as volume of sales, volume of sales within given price ranges, listing time for properties, listing price versus selling price for the properties handled by the one or more real estate agents, number of years of experience, type of properties handled by the one or more real estate agents, feedback from clients, feedback from other real estate agents, escrow times, ability to double-end a deal, ability to attract cash buyers, and responsiveness. Alternatively, the agent search results may be in the form of listings of one or more properties, wherein each property lists a top performing real estate agent or a ranking of real estate agents for the property or provides a link to a pop-up, web page, or application listing the top performing real estate agent or a ranking of real estate agents for the property.

The agent search results as initially provided to the user may include anonymous real estate agent data. Anonymous real estate agent data may be provided until the user performs one or more activities selected from registering with the system, requesting the system to contact the agent or agreeing to the terms of service with the system. Once the user performs one or more activities as required by the system, the contact information for the real estate agents may be populated into the agent search results. The agent search results may also remain anonymous with regard to ranked real estate agents who have not agreed to represent the user based on the terms of representation of the real estate ranking system. The terms of representation may be provided to the ranked real estate agents from the system administrator or automatically through the system. Once the anonymous ranked real estate agents agree to the terms of representation, their information may be provided to the user or populated into the web based user portal.

As previously described, the system may include a web based user portal generated for each user. The web based user portal may be a web page or application which hosts system information specific to the user. The user may be able to log into the web based user portal through the system web page or mobile device application by utilizing the user's username and password or by clicking on a link provided to the user. The web based user portal may also provide the interface through which the user communicates to the system administrator or agents listed in the web based user portal. The web based user portal may perform one or more functions including storing real estate agent searches, selecting a real estate agent, providing a mechanism for communication of agent search results from the system to the user, providing a mechanism for populating agent search results with contact information after real estate agents agree to representation, storing preferences of the user, comparing real estate agents with the agent search results, calculating the potential financial benefit for selecting one agent over another, maintaining a personal profile, updating search criteria for saved searches, providing updates to agent search results, updating list of properties based on availability of property, allowing communication with real estate agents, allowing for document sharing between user and real estate agents, document signing, instant messaging with real estate agents, and allowing the user to terminate relationship with one or more real estate agents.

As described, the web based user portal may allow for users to input information relating to their specific needs. The information input by the user may be utilized to rank two or more real estate agents pursuant to the data analysis algorithm to obtain a top ranked real estate agent or may be utilized to modify rankings or performance matching values for the ranked agents. Examples of types of information input into the web based user portal by the user may include geographical area, budget/desired price, and additional user preferences. The web based user portal may additionally utilize a tool allowing the user to quickly modify areas of importance to the user and update the real estate rankings in real time. Such a tool may utilize a slide bar or other functionality allowing the user to quickly change the weighting associated with a characteristic of the real estate agent or property involved.

The web based user portal may display agent search results for one or more real estate agents. Any performance information for the ranked real estate agents may be statistical data or may highlight specific transactions. Agent search results for the top performing real estate agent based on the submitted search criteria may be initially provide to the user. If the user wishes to compare or view additional agents, the user may request that the web based user portal be updated with agent search results for additional agents as desired. This may be performed by clicking on an additional agent icon or selecting an option within the web page or application. Any real estate agents added to the displayed agent search data will be selected from the ranking based on the submitted search criteria. If the user elects to add one additional real estate agent, the top ranking real estate agent based on the submitted search criteria which is not currently displayed will be added. If the user elects to add two additional real estate agents, the two top ranking real estate agents based on the submitted search criteria which are not currently displayed will be added. The same will apply for 3 or more added real estate agents. The user may also select an option within the web based user portal to initially show agent search results for a desired number of agents at a time. This will allow the user to view agent search results for 2, 3, 4, or more agents at a single time as desired by the user. By displaying information for two or more real estate agents, the web based user portal allows the user to view agent search results for two or more agents at a time for comparison purposes. The user may also be able to select the type of data included in the agent search results and modify the layout of the agent search results as displayed. For purposes of comparison, the average performance data for all real estate agents based on the search criteria may also be provided to the user.

The web based user portal may provide for selection of the real estate agent by the user. To allow for selection of a real estate agent based on the agent search results, anonymous agent search results may be displayed on the web based user portal for one or more real estate agents. Alternatively, identifying information may be provided for each listed real estate agent. As discussed, the user may select the number of real estate agents which are displayed. The user may also be able to rearrange the search results on the page based on importance of certain performance criteria or agent characteristics included in the agent search results. The user may then be able to select which agent the user wishes to retain for the desired real estate transaction based on the search criteria submitted by the user. To select a real estate agent, the user may click on an icon associated with each real estate agent. The web based user portal may also include an option for selecting the desired real estate agents. Once selected, the desire of the user to be represented by the agent may be communicated to the agent. If the agent accepts the representation, the contact information for the agent is populated into the agent search results. The agent may be contacted automatically by email or text message via the system. Alternatively, the agent may be contacted by telephone or in person by the system administrator. Once the contact information for the selected agent is populated, the agent search results for the remaining real estate agents may remain anonymous. The user may be informed by email, text message, or other forms of communication that the contact information for the desired real estate agent is updated into the system. If additional real estate agents are added to the search by the user, the newly added real estate agents may also remain anonymous. This will prevent the user from retaining multiple agents for representation for the same real estate property transaction. To select one of the remaining anonymously listed agents, the user may have to first terminate the relationship with the selected real estate agent.

Within the web based user portal, the user may be able to select an option to terminate the relationship with the selected real estate agent. This function may be accomplished by clicking on an icon associated with the selected real estate agent. The web based user portal may also include an option for terminating the selected real estate agent. Once a real estate agent is terminated, the user may then select one of the remaining real estate agents listed anonymously in the agent search result as previously described. If no other agents are listed anonymously in the portal, the highest remaining real estate agent based on the search criteria may be provided to the user as described herein. The termination function will provide a benefit to the user as terminating a relationship with a retained agent may present an uncomfortable situation for the user. To prevent users from terminating agents without good cause, additional pop-ups may be utilized to request information regarding the current relationship prior to allowing termination. The information received from the user may be utilized for one or more functions including updating performance data for the terminated real estate agent, updating search results for the user, and understanding the nature of the specific real estate transaction.

As described, user may also select to add one or more real estate agents to the real estate agents listed in the agent search results. This will aid the user in providing the capability for the user to compare one or more agents within the web based user portal. This may be performed by selecting an option or clicking on an icon for adding an additional agent, whereby one or more real estate agents will be added to the displayed agent search results based on the ranking of the real estate agents in the agent search results. For example, if the user elects to add one additional agent, the top ranking real estate agent not currently displayed will be added to the displayed agent search results. Any newly added real estate agents may remain anonymous until selected by the user pursuant to the selection process. The contact information for the newly selected agent will then be populated pursuant to the process for agent selection described herein.

The web based user portal may also allow the user to initiate and manage multiple searches for different geographies, price ranges, and property types. To this end, the web based user portal may include the capability to allow the user to perform two or more searches in relation to two or more real estate properties whereby each search includes a set of agent search results based on the search criteria specific to each property. This will benefit the user by allowing the user to look for real estate agents based on properties in separate and distinct locations. This is a beneficial feature as real estate transactions may vary between neighborhoods, large metropolitan areas, or niche property types. This feature will allow the user to manage two or more potential real estate transactions while minimizing any potential overlap between retained agents. This feature will also allow a user to manage transactions where by the user is buying one or more properties and selling one or more properties. This is another beneficial feature of the web based user portal as the user may manage multiple transactions within the web based user portal as a buyer or seller.

When displaying two or more searches, each search result or agent scorecard may be shown in a separate and distinct fashion in the web based user portal. Each search may be listed as a line item with a link to the transaction specific information in a separate webpage. Each search may also be shown in separate windows within the web based user portal or pop-ups. Alternatively, the web based user portal may be transaction specific whereby a new web based user portal is generated for each new set of agent search results submitted by a user. Where the web based user portal is transaction specific, a link to the web based user portal may be sent to the user once the agent search results are populated with contact information for the real estate agents listed therein. In this example, the user may be able to view the populated real estate agent data and communicate with the listed real estate agents through the web based user portal.

The functionalities of the web based user portal may be dependent on whether the user is a potential buyer or seller of a real estate property. This will allow the web based user portal to be better tailored towards the needs of the user. For example, the web based user portal may be a residential buyer-specific portal, a residential seller-specific portal or a commercial portal.

In the example of a residential buyer-specific portal, the user may utilize the web based user portal to ensure they select an agent with the most expertise for their property purchase. In this example, the user may select whether they want a city generalist to guide the user on what neighborhood to select, or a neighborhood specialist to guide the user on selecting a neighborhood in a metro area (e.g., Chicago and its suburbs). The user may then complete fields relating to budget and geographical area. In this regard, the user may enter a metropolitan area and budget if they are preapproved for a loan or a cash buyer. Additional details that may be entered by the user may include a timeline, how long the user's commute will be, school zone preference, whether the user wants a new build or an existing home specialist, brokerages/agents to exclude, number of bedrooms and bathrooms, lot size range, property square footage range, architectural style, and other personal preferences of the buyer. Once all the information has been input, the user may then select the type of analysis. With respect to the type of analysis, the user may select “Overall Best” agent, or customize analysis to be biased based on selected agent performance areas and/or personal preferences of the user.

In the example of a residential seller-specific portal, the user may utilize the web based user portal to ensure they select an agent with the most expertise for their property sale. In this example, the user may first enter the address of the property the user wishes to sell. Once the address is input by the user, the system will query one or more data sources to pull home details (e.g., currently listed sale price/approximate value, # of bedrooms, # of bathrooms, total square feet, lot size, date of construction, etc.). Once the data is pulled by the system, the system may require the user to confirm the details to ensure that the data pulled from data source is accurate. The user may then input additional details such as brokerages/agents to exclude, termination date of current listing agreement (if applicable), showing instructions, tenant occupied, renovations, timeline, and other personal preferences of the seller. Once all of the necessary information is input, the user may then select the type of analysis. The user may select “Overall Best” agent, or customize analysis to be biased based on selected agent performance areas and/or personal preferences of the user.

In the example of a commercial portal, the user may utilize the web based user portal to ensure they select an agent with the most expertise for a commercial property transaction. In this example, the user may first select if they are a buyer, lessee, seller, or lessor. If the user is a buyer, the user may then select options similar to those offered in the residential buyer specific portal as they relate to a commercial property. If the user is a seller, the user may then select options similar to those offered in the residential seller specific portal as they relate to a commercial property. If the user is a lessor or lessee, additional information may be input such as lease amounts, term of lease, ability to remodel or perform construction on the property.

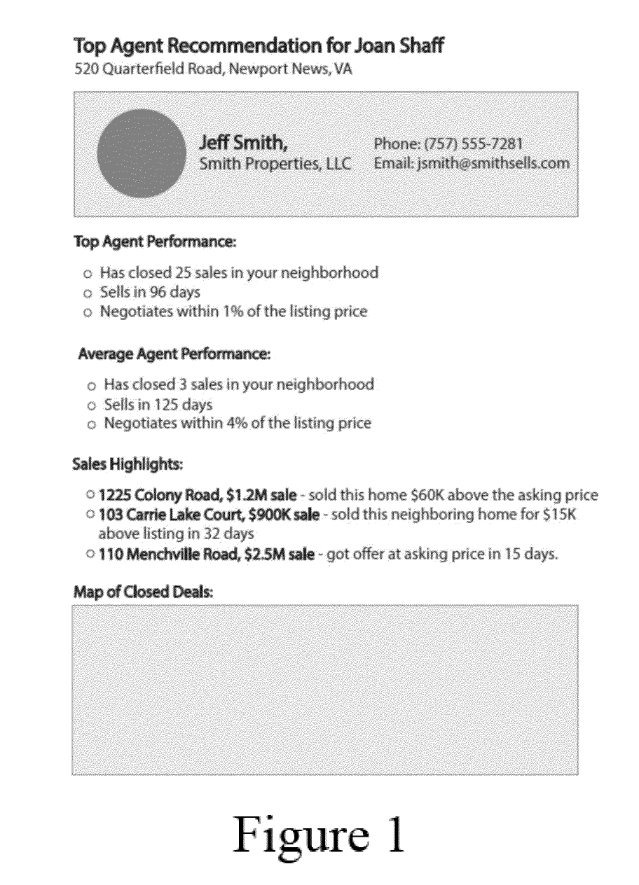

Once the user is registered and inputs the necessary information into the system, agent information for one or more agents may be provided to the buyer or seller. The agent information for the one or more agents may be may be in the form of an agent scorecard as shown in FIG. 1. The agent scorecard client may display features of the selected agent's past performance that will help the user decide whether to select the agent. As previously discussed, the agent information may be initially anonymous until certain criteria are met by the user or the agent.

The agent report card may include one or more of the features selected from the agent's average performance on transactions near the user's search region, the agent's average performance on all real estate transactions, the agent's sales highlights, including address and closed price, that show individual sales nearby the user's search area, a map of the agent's current listings and closed deals. the agent's social media page, website reviews, agent reviews, and positive testimonials, the agent's image or the brokerage logo, photos of past sold or purchased homes, and a characterization of the agent's expertise, such as “Buying Expert”, “Leasing Specialist”,“Top Short Sale” and “REO Broker.”

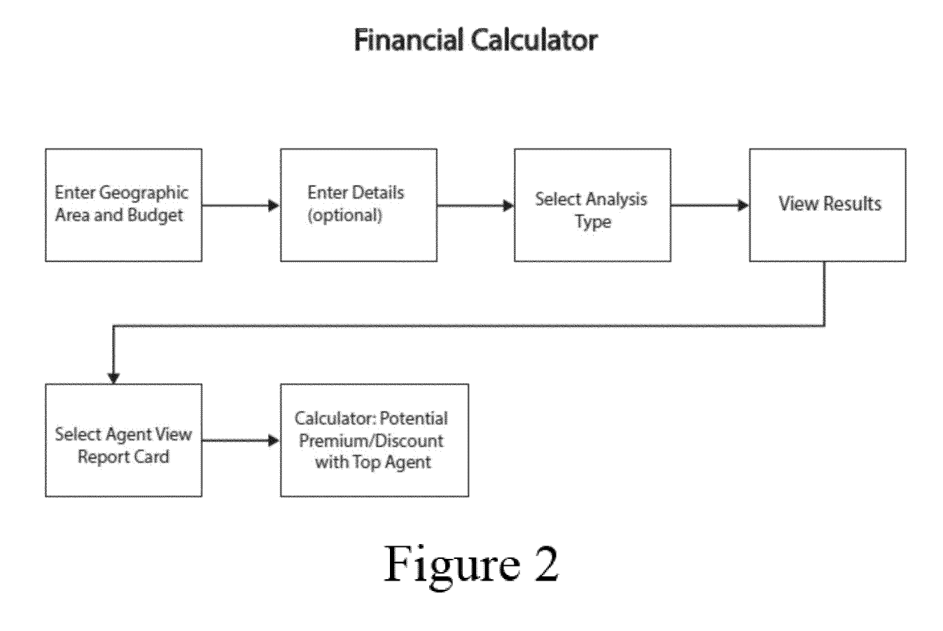

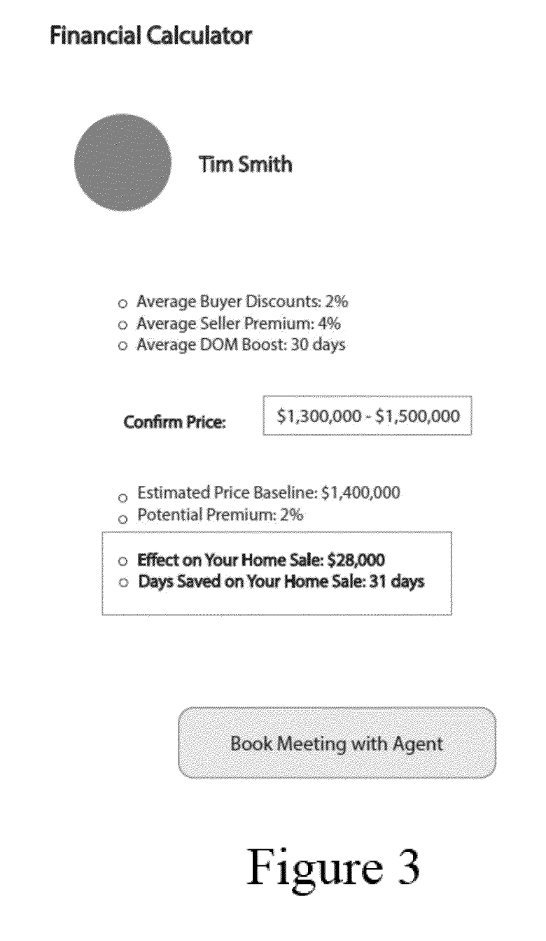

The web based user portal may also include a financial calculator functionality allowing the user to calculate a potential financial benefit to the user based on the selected agent. The financial calculator may be used to estimate the potential financial benefit that the user would receive by working with the selected agent, if the selected agent's historical performance is similar in the subject transaction. An example of the output of the flow of the financial calculator is shown in FIG. 2 and an example of the output of the financial calculator is shown in FIG. 3. To use the financial calculator, the user would confirm their agent selection as well as the approximate budget for their home purchase or ideal price for their home sale. Given the agent's historical performance in the user's area of interest, the system would produce a price performance metric that shows the percentage above or below the original listing price of a home that the final price of a home is, both for the top agent and the average performance in the neighborhood. For example, a top buyer's agent might negotiate an average 3% discount on homes in a given neighborhood. If the user selected this buyer's agent and indicated a budget of $1,000,000, then this calculator might demonstrate:
1) The potential closed price of $990,000 that a user might get by working with an average agent;
2) The potential closed price of $970,000 that a user might get by working with a top agent; and
3) The potential savings of $20,000 gained by using a top agent.

Once users have input their needs, reviewed the agent analysis, and selected an agent from among their top search results, the user may contact an agent through the web based user portal. Upon selecting an agent and the agent accepting representation of the user pursuant to the terms of the system, the contact information for the user and agent may be exchanged via the system. Alternatively, the contact information for the user may only be provided to the selected agent or the contact information for the agent may only be provided to the user. The user and agent may communicate via the web based user portal via email, text message, online chat, video call, VOIP or other types of electronic communication. The user or agent may also schedule a meeting with the other party through the web based user portal utilizing a calendar function. If the agent is not already registered with the system, the agent may receive an email an automatically generated email from the system based on the agent's published contact information. An unregistered agent may also be contacted by telephone or other types of communication directly from the system administrator or the user.

Agents may also register with the real estate ranking system. While the agent may register with the system at any time, this may not guarantee that the agent will be referred to a system user or included in a ranking of real estate agents. As such, it is likely that an agent will register with the system upon being contacted with regard to a potential referral to a buyer or seller of a real estate property via the real estate ranking system. To register with the system, the agent may submit personal information to the system. The agent's personal information may include one or more selected from name, address, age, phone number, email address, credentials, and credit card information. Submission of the personal information may be necessary for the agent to be provided with the contact information regarding any potential referrals. Submission of credit card information will allow the agent to purchase goods or services through the system. Upon entering the personal information, the agent may be prompted to create a username and password to finalize registration with the system. The username and password may allow the agent to access a web based agent portal which provides various functionalities to registered agents. Upon registration an email may be sent to the agent confirming registration. The confirming email may also provide a link to the web based agent portal.

The web based agent portal may be a web page or application which hosts system information specific to the agent. The agent may be able to log into the web based agent portal through the system web page or mobile device application by utilizing the username and password used to register with the system. The web based agent portal may also provide the interface through which the agent communicates within the system. The web based agent portal may include one or more functionalities selected from communication of referral information to agent, acceptance of terms of representation, population of referral information of potential clients for the agent, communication of status updates from agent, communication of status updates from agent to user, and communication between agent and user.

The agent may accept the representation of the user and accept the terms of the system electronically or manually. The agent may accept the representation of the user and the terms of the system via an electronic system allowing for acceptance of contract terms. Alternatively, the agent may agree to the terms through standard forms of contract acceptance. Upon agreeing to represent the user and agreeing to the terms of the system, the contact information of the user and search criteria submitted by the user may be populated into the web based agent portal. Once populated, the agent may receive a communication informing the agent that contact information for the user is populated and ready for review.

Once the user information is populated into the web based agent portal, the agent may then communicate with the user, provide updates to the user, and share information with the user with regard to the properties in the scope of the search criteria submitted by user. For example, the agent may utilize the system to share listings within the scope of the search criteria with the user to allow the user to select certain properties for viewings. The portal may also allow the agent to share a calendar or scheduling information with the user for purposes of scheduling viewings, showings, closing dates or other types of meetings. The agent may also utilize the web based agent portal to share real estate transaction documents or to obtain necessary signatures on documents pursuant to the closing process.

The web based agent portal may also allow agents to manage multiple transactions. This feature will allow the agent to interact with multiple users within the system whether representing users in the purchase or sale of real estate properties. When displaying two or more transactions, each transaction may be shown in a separate and distinct fashion in the web based agent portal. Each transaction may be listed as a line item with a link to the transaction specific information in a separate webpage. Each transaction may also be shown in separate windows within the web based agent portal or pop-ups. Alternatively, the web based agent portal may be transaction specific whereby a new web based agent portal is generated for each new transaction referred to the agent. Where the web based agent portal is transaction specific, a link to the web based agent portal may be sent to the agent once the agent agrees to represent the user and agrees to the terms of the system.

The system may also provide access to the system administrator and assist the system administrator with management of the users, agents and transactions in the system. The system administrator may thus be able to populate user information for agents, populate agent information for the users, manage communications within the system, ensure the agents are providing timely updates to the users, and remove users and agents from the system. Such functionalities may be performed automatically within the system based on conditions set up the system administrator or may be manually performed within the system by the selection of various options available to the system administrator. The system may also allow the system administrator to communicate with users and agents via email, text message, instant messaging or other communication types available within the system. The communication functionality available to the system administrator will allow the system administrator to be able to monitor and ensure any pending real estate transactions are progressing without problems. The communication functionality will also allow the system administrator to receive feedback from the user and agent once a real estate transaction is complete.

To further assist the system administrator, the system may include additional functionalities which allow the system administrator to oversee and manage all transactions in the system. To accomplish this, the additional functionalities may allow the system administrator to summarize, display and export data relating to two or more selected transactions. This will allow the system administrator to view average transaction times, overall satisfaction with a selected agent, sales or purchase data relating to a geographic region or specific type of property or any other transaction related information as it may related to one or more transactions, users or agents within the system.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

1. A method for providing a referral of a ranked real estate agent through a real estate agent referral system comprising the steps of:
receiving search criteria from a user with respect to the purchase or sale of a real estate property;
receiving performance data for two or more real estate agents;
ranking by a computer two or more real estate agents based on the search criteria received from the user and the performance data of the two or more real estate agents to create a set of agent search results including the highest ranking real estate agent or a listing of the highest ranking real estate agents based on the search criteria, wherein the search results include performance data for the highest ranking real estate agent or each of the real estate agents listed in the listing of the highest ranking real estate agents;
generating a web based user portal displayed on a personal computer or a mobile device, the web based user portal allowing the user to view the agent search results, select a real estate agent from the agent search results, and transact business with the selected agent.

2. The method according to claim 1, wherein the set of agent search results are in the form of a list of one or more properties, wherein each specific property included in the list of one or more properties displays the top ranked real estate agent or the listing of the highest ranking real estate agents for the specific property.

3. The method according to claim 2, wherein the list of one or more properties is continually updated based on changes in the listing data of the one or more properties included in the list of one or more properties.

4. The method according to claim 1, wherein the set of agent search results is anonymous with respect to the one or more real estate agents.

5. The method according to claim 4, further comprising the steps of:
populating the contact information for the agent selected by the user into the web based user portal upon the selected agent agreeing to represent the user and accepting the terms of the real estate agent referral system.

6. The method according to claim 1, further comprising the step of:
storing the set of agent search results within the web based user portal for retrieval by the user.

7. The method according to claim 7, further comprising the step of:
updating the set of agent search results based on changes in the performance data for the one or more real estate agents included in the set of agent search results.

8. The method according to claim 1, further comprising the step of:
terminating the relationship with the real estate agent selected by the user, wherein the web based user portal includes an option for the user to terminate the relationship with the selected real estate agent.

9. The method according to claim 8, wherein the web based user portal includes an option for the user to select another agent from the set of agent search results upon terminating the relationship with the initially selected agent.

10. The method according to claim 1, further comprising the step of :
providing one or more additional sets of search criteria, wherein the agent search results for each additional set of search criteria are displayed in the web based user portal.

11. The method according to claim 1 further comprising the step of:
creating a communication interface between the user and the real estate agent selected by the user, wherein the communication interface is created between the web based user portal and a web based agent portal, the web based agent portal allowing the selected agent to view personal information of the user and communicate with the user.

12. The method according to claim 11, wherein the personal information of the user is populated into the web based user portal once the selected agent agrees to represent the user and agrees to the terms of the real estate agent referral system.

13. The method according to claim 11, wherein the web based agent portal includes a schedule function which allows the agent to post available times viewable to the user and schedule appointments with the user.
